(19) United States
(12) Patent Application Publication
(10) Pub. No.: US 2014/0034477 A1
(43) Pub. Date: Feb. 6, 2014

(54) Water Supply Systems

(71) Applicant: Mads Landrok, San Jose, CA (US)

(72) Inventor: Mads Landrok, San Jose, CA (US)

(21) Appl. No.: 14/111,931

(22) PCT Filed: Mar. 27, 2012
(86) PCT No.: PCT/GB12/50673

§ 371 Date: Oct. 15, 2013

(30) Foreign Application Priority Data
Apr. 15, 2011 (GB) 1106403.7

(51) Int. Cl. C02F 1/14

(52) U.S. Cl. CPC C02F 1/14
USPC 203/10; 202/185.3

(57) ABSTRACT

A water supply system, the system comprising: an evaporation station, the evaporation station comprising a water inlet, an air conduit, and a water evaporation system coupled to the water inlet and to the air conduit for converting water from the water inlet into water vapour and for providing the water vapour onto the air conduit to provide humidified air; a condensation station having an air inlet to receive the humidified air, a water outlet, and a water condensation system coupled to the air inlet and to the water outlet to extract water from the humidified air and provide the extracted water to the water outlet; a pipe coupled between the air conduit of the evaporation station and air inlet of the condensation station; and a system for driving an airflow through the air conduit of the evaporation station past the water evaporation system to enhance the spray evaporation.

### FIELD OF THE INVENTION

This invention relates to systems and methods for supplying water, in particular fresh water from sea water.

### BACKGROUND TO THE INVENTION

Known techniques for extracting fresh water from sea water include multi-stage flash distillation (MSF), reverse osmosis, and a system described in a PhD dissertation from Technical University of Munich by Hendrik Müller Horst entitled “Multiple Effect Humidification Dehumidification at Ambient Temperatures” (available here: http://mediatum2.ub.tum.de/node?id=601861), which involves using a solar collector to heat sea water which afterwards enters an evaporation chamber, extracting the distillate from the subsequent condensation of the generated steam. Background prior art can be found in U.S. Pat. No. 6,919,000, U.S. Pat. No. 7,225,620, U.S. Pat. No. 7,832,714, and US2010/0314238. Further background prior art can be found in: US2011/0056822; DE102008026673; FR2902666A; WO03/013682; WO2007/013099; and WO02/42221.

There is, however, a need for improved techniques.

### SUMMARY OF THE INVENTION

Broadly speaking we will describe a water supply system, the system comprising: an evaporation station, the evaporation station comprising a water inlet, an air conduit, and a water evaporation system coupled to said water inlet and to said air conduit for converting water from said water inlet into water vapour and for providing said water vapour onto said air conduit to provide humidified air; a condensation station having an air inlet to receive said humidified air, a water outlet, and a water condensation system coupled to said air inlet and to said water outlet to extract water from said humidified air and provide said extracted water to said water outlet; and a pipe coupled between said air conduit of said evaporation station and air inlet of said condensation station.

In broad terms the inventor has recognised that once in vapour form water can be transported, for example upwards, without significant expenditure of energy. Furthermore the movement of air can be employed to improve the efficiency of an evaporation process, and in warm climates these observations can be combined to fabricate a water desalination system.

In embodiments the pipe has a length of at least 10 m, 100 m, 1 km, 10 km or 100 km, and in a large scale system the pipe may have a length of some 10 s of kilometres. Two alternative embodiments may be employed, one in which the pipe, evaporation station, and condensation station define a closed loop air path, and another in which the condensation station is located at a greater elevation than the evaporation station, for example at more than 10 m, 100 m or 1000 m above the evaporation station, for example on a hill or towards or at the top of a tall building. Nonetheless, some of the benefits of the invention may be obtained by locating both the evaporation station and the condensation station adjacent to a body of water, preferably substantially co-located with one another, whether or not there is a closed loop air path. This is because the body of water may be employed for efficient water condensation. Where the condensation station is above the evaporation station, energy may be extracted from the gravitational potential energy of the condensed water, for example for hydroelectric power generation.

Embodiments of the system employ a pipe with an outer surface having a solar radiant heat absorbance of at least 40%, 50%, 60%, 70%, 80% or 90% at a wavelength in the range 300 nm to 2000 nm. This may be achieved, for example, by colouring the pipe black and/texturising or otherwise configuring the surface of the pipe. In this way solar energy may be employed to assist in driving the humidified air through the system, and also to assist in maintaining the temperature of the air on its passage through the system to thus maintain the water vapour content of the air until the condensation station is reached. Optionally the system may include a solar heating system or solar concentrator to heat the pipe, for example comprising a series of mirrors along the pipe to gather and direct sunlight towards the pipe. Additionally or alternatively the pipe may be configured for heat storage and/or may be thermally insulated.

The skilled person will recognise that employing solar energy to provide heat to the humidified air in the pipe does not necessarily imply that the temperature of the air will rise or remain substantially constant—for example in a system in which the humidified air is transported to a significant height above the evaporation station the air temperature may drop even though solar energy is being supplied to the humidified air.

Additionally or alternatively the pipe may be heated using power from another renewable energy source and/or by means of waste heat from a power station employing fossil or nuclear fuel or some other source of heat.

Because the temperature of the humidified air drops, in particular in embodiments in which the condensation station is above the evaporation station, the pipe may include one or more water collection or extraction points along the length of the pipe, to remove condensed water from the pipe. However in some preferred implementations the degree of humidity of the humidified air at the evaporation station is adjusted so that at the condensation station (where the air temperature is reduced) the relative humidity is kept below a threshold of 100% (i.e. below the dew point), although in embodiments the threshold may be lower, for example 80% or 90%.

In some preferred embodiments the system is configured for large scale operation, and thus the pipe has a cross-sectional area of at least 1 m², 5 m² or 10 m². In other embodiments the system may be employed at a smaller scale on a boat or other seaborne vessel.

Preferably the system also incorporates one or more fans or turbines to drive a flow of the humidified air though the pipe. In preferred embodiments one or more of these is located within the air conduit.

In preferred embodiments the water evaporation system comprises one or more spray evaporators, which can deliver substantial volumes of water into fast moving air. Thus preferably the water evaporation system comprises one or more sets or rings of nozzles within the air conduit, after the turbines or fans in a direction of the airflow, pointed to direct water droplets into a direction of the airflow. In embodiments the airflow is at least 1 m/s, 5 m/s, 10 m/s, 20 m/s or 30 m/s. Preferably an average dimension of a droplet is no more than 500 μm, 400 μm, 300 μm, 200 μm, or 100 μm, for rapid evaporation. In embodiments, particularly those for moving fresh water, substantially all the water received by the water evaporation system may be converted into water vapour.

In some preferred embodiments the system is used to collect and evaporate salt water, which is transferred as water vapour to the condensation station where freshwater is retrieved, thus in embodiments the evaporation station and/or pipe also includes a brine collection system to collect brine resulting from the evaporation process. When used for desalination the system may be mounted on a sea-going vessel.

In some embodiments the system is configured to take account of the differential day/night heating and cooling of the ocean with respect to the desert. Thus in embodiments the system includes a controller to control day/night operation of the system, to operate the forced air flow at night when the relative temperature difference between the evaporation and condensation stations is larger. To facilitate this, in embodiments the system includes one or more water storage pools at or in fluid communication with the evaporation station, preferable thermally insulated for heat retention. Optionally these or their water inlets may be heated, for example by a solar heater such as a solar concentrator, or by other means, for example using waste heat/power from a power station. Then the controller may be configured to draw water into a pool for heating during the day, and to operate the forced air flow at night.

In embodiments the condensation station may comprise a heat exchanger thermally coupled to the air and/or ground in combination with a water collection system to collect water condensed from the humidified air. In embodiments the heat exchanger may have a tree or fan-type structure akin to a ‘lung’.

Additionally or alternatively the condensation station may include a heat engine such as a Stirling engine, or other energy harvesting system, driven by the temperature difference there (which may be >20° C., >30° C., >40° C., or >50° C.), for example thermally coupled to the heat exchanger. Energy from the heat engine may be employed to drive one or both of said water evaporation system and said airflow driving system.

### BRIEF DESCRIPTION OF THE DRAWINGS

These and other aspects of the invention will now be further described, by way of example only, with reference to the accompanying figures in which:

FIG. 1 shows a first example of a water supply system according to an embodiment of the invention;

FIG. 2 shows a second example of a water supply system according to an embodiment of the invention; and

FIG. 3 shows a third example of a water supply system according to an embodiment of the invention.

### DETAILED DESCRIPTION OF PREFERRED EMBODIMENTS

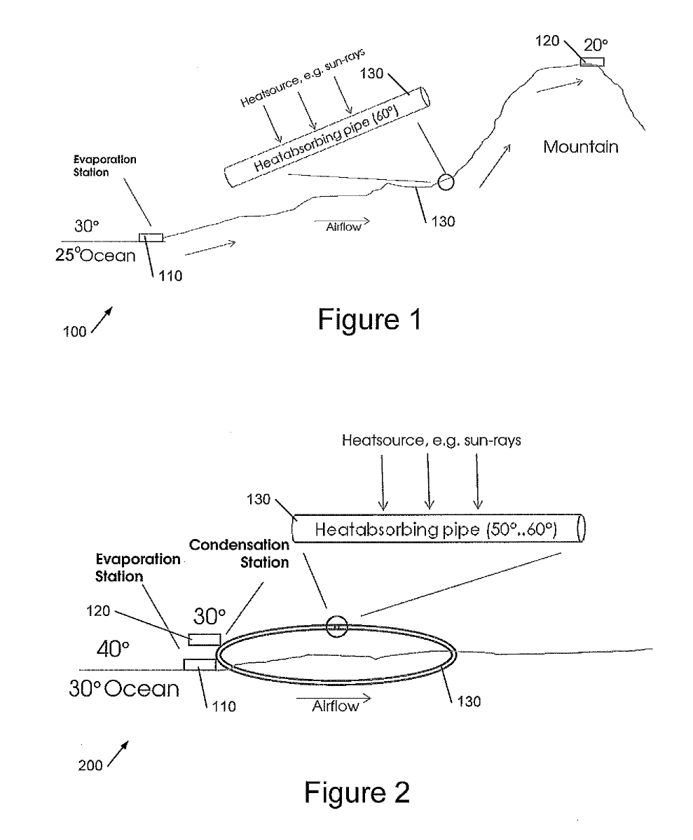

Referring to FIG. 1, this shows an embodiment of a water supply system 100 comprising an evaporation station 110 located adjacent an ocean, and a condensation station 120 located on top of a hill or mountain. These two stations are connected by a heat absorbing pipe 130. The ocean temperature may be, for example, of order 25° C. and the local air temperature of order 30° C.; the heat absorbing pipe 130 may heat the humidified air inside up to perhaps 60° C., and the local air temperature at the condensation may be or order 20° C.

The evaporation station comprises a water inlet to one or more spray evaporators and, preferably, one or more turbines of a similar design to those employed in wind tunnels of a similar diameter to that of pipe 130 (albeit the skilled person will appreciate that the pipe could be of smaller or larger diameter than that at a location of a turbine to adjust pressure/wind speed). Natural convection draws the warm, humidified air up to the condensation station, but for improved evaporation efficiency and greater water transport it is preferable to add a forced drive to the humidified air. In particular in a closed loop system multiple forced drives or turbines may be employed, before, after, and in between the evaporation and condensation stations.

The condensation station 130 preferably comprises one or more heat exchangers in combination with guttering or similar to collect the condensed water. Optionally a return pipe may be included from the condensation station back to the evaporation station, to encourage a greater air flow speed.

Example parameters for the system of FIG. 1 are given below:
The pipe (radius r=5.64 m, i.e. cross-sectional equivalent area of 100 m²) is laid out from the Ocean to the mountain top (100 km long)
Windspeed in pipe 30 m/s
   =>3,000 m³ air/s
Saturation at
   20°: 0.017 kg/m³
   30°: 0.030 kg/m³
   =>Δ(30° . . . 20°: 0.013 kg/m³
=>39 kg H₂O/second=140,400 l/hr=37,090 gl/hr

### Example 1

In embodiments the evaporation station preferably also includes a system to collect brine which is a bi-product of the evaporation process. This may be delivered via an outlet pipe back into the ocean. The brine collection may also, or alternatively, be part of the pipe with such outlets along the pipe as may be required.

Referring now to FIG. 2, this shows an alternative embodiment of a water supply system 200, in which the pipe 130 defines a closed loop air flow. In this example it is again preferable (but not essential) to employ one or more turbines within the pipe to improve the air flow. As illustrated the evaporation station 110 and condensation station 130 are substantially co-located, and are both located adjacent the ocean. This facilitates water condensation for the condensation station 130; solar energy is input to the system via pipe 130, which in embodiments is black or transparent.

Example parameters for the system at FIG. 2 are given below:
The pipe (radius r=3.99 m i.e. equivalent cross-sectional area of 50 m²) is laid out in a loop
Windspeed in pipe 30 m/s
   =>1,500 m³ air/s
Saturation at
   30°: 0.030 kg/m³
   50°: 0.083 kg/m³
   =>Δ(50° . . . 30°: 0.053 kg/m³
=>79.5 kg H₂O/second=286,200 l/hr=75,606 gl/hr

### Example 2

The pipe (r=1,78, ie area of 10 m²) is laid out in a loop, 159 m in radius (1,000 m long)
Windspeed 10 m/s
   =>100 m³ air/s
Saturation at
   30°: 0.030 kg/m³
   60°: 0.130 kg/m³
   =>Δ(60° . . . 30°: 0.100 kg/m³
=>100 kg H₂O/second=360,000 l/hr=95,100 gl/hr

### Example 3

The pipe (r=0.56 m, ie. area of 1 m²) is laid out in a loop, 15.9 m in radius (100 m long)
Windspeed 10 m/s
   =>10 m³ air/s
Saturation at
   30°: 0.030 kg/m³
   50°: 0.083 kg/m³
   =>Δ(50° . . . 30°: 0.053 kg/m³
=>0.530 kg H₂O/second=1,908 l/hr=504 gl/hr

### Example 4

Thus broadly speaking by increasing wind speed whilst actively dispersing water into the air we increase the surface/evaporation rate manifold, in embodiments by employing one or several turbines in combination with the active dispersion. In some preferred implementations we transport the vapor up, out and away from the evaporation station. Embodiments of the evaporation station merely employ a steady flow of water to be purified and as such no input reservoir (other than, for example, the ocean) is required. In some deployment scenarios (where the condensation station is at an elevated height and/or in a colder local climate) there is also the possibility of harvesting potential (or kinetic) energy through distribution of the condensed water as well as making use of natural differences in temperature. In embodiments of the system may be deployed on a very large scale (>0.1 km, >0.5 km, >1 km or >10 km), and a solar (or other renewable) heated pipe may then be advantageously employed in the system to transport the water vapour.

In some preferred implementations the degree of humidity of the humidified air in the pipe is adjusted to ensure that close to full humidity is ensured at the condensation station (where the temperature of the pipe immediately prior to the condensation temperature may be lower than in other parts of the pipe e.g. due to reduced temperatures surrounding the condensation station).

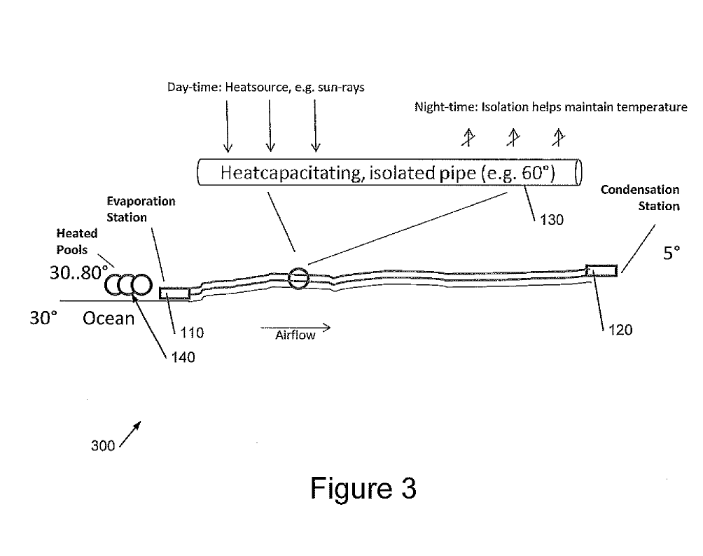

FIG. 3 shows a further embodiment of the system 300, where the condensation station 120 is located in a desert. The evaporation station 110 is coupled to a set of heated pools 140 and during the day-time the system takes in sea water (for example at 15-35° C.) and isolates the sea water in these heated pools. In embodiments the water is heated by solar concentrators, and the pools are also thermally insulated; thus they acquire and retain a relatively high temperature (30° C.-80° C.). At night, the system blasts vapour through the connecting pipe 130 to the condensation station 120 in the desert, which at night may be cold, for example <10° C. It will be appreciated that because at night the ambient temperature of land, in particular in the desert, drops faster than that of the sea, even without heating of the pools, this approach can provide useful advantages.

In embodiments of the above described systems the pipe may be provided along some or substantially all of its length with heat storage means for storing heat supplied to the pipe from an external source. This helps to retain the externally supplied heat during the day, and also provides a degree of thermal isolation of the pipe at night. Similarly the externally supplied heat may be provided along some or substantially all of the length of the pipe. This external heating may employ a solar concentrator partly surrounding the pipe, for example a set of mirrors at intervals along the length of the pipe, or such heat may be supplied from another renewable source, or by using fossil fuel, or by employing waste heat from another source.

No doubt many other effective alternatives will occur to the skilled person. It will be understood that the invention is not limited to the described embodiments and encompasses modifications apparent to those skilled in the art lying within the spirit and scope of the claims appended hereto.

1. A water supply system, comprising:
an evaporation station, the evaporation station comprising a water inlet, an air conduit, and a water evaporation system;
wherein said water evaporation system is coupled to said water inlet to receive water for evaporation and has a water spray outlet into said air conduit to convert water from said water inlet into water vapour for humidifying air in said air conduit by spray evaporation, to provide humidified air;
a condensation station having an air inlet to receive said humidified air, a water outlet, and a water condensation system coupled to said air inlet and to said water outlet to extract water from said humidified air and provide said extracted water to said water outlet;
a pipe coupled between said air conduit of said evaporation station and air inlet of said condensation station; and
a system for driving an airflow through said air conduit of said evaporation station past said water evaporation system to enhance said spray evaporation.

2. The water supply system of claim 1 wherein:
said pipe has a length of greater than 1000 m; and
said pipe has a cross-sectional area of at least 10 m².

3. The water supply system of claim 1 wherein
said evaporation station and said condensation station are substantially co-located,
wherein said water condensation system of said condensation station further comprises a water inlet for cooling water for said water condensation system.

4. (canceled)

5. (canceled)

6. The water supply system of claim 1, further comprising
a solar heating system or solar concentrator to heat said pipe.

7. The water supply system of claim 1, wherein
said pipe has an outer surface with a solar radiant heat absorbance of at least 50%.

8. The water supply system of claim 1, wherein
said evaporation station comprises one or more water storage pools said system further comprising heating means to heat a said water storage pool.

9. (canceled)

10. The water supply system of claim 8 further comprising
a controller to control the system to draw water into a said water storage pool during the day for storing heated water for use by said system, and to operate to drive said airflow through said air conduit of said evaporation station at night.

11. The water supply system of claim 1, wherein
said pipe includes one or more water collection or extraction points along a length of the pipe.

12. The water supply system of claim 1, wherein:
said air conduit comprises one or more powered turbines or fans, and wherein
said water evaporation system comprises a set of nozzles within said air conduit, after said turbines or fans in a direction of said airflow, pointed to direct water droplets into a direction of said airflow, and
wherein said airflow is at least 5 m/s and an average dimension of a said droplet is no more than 200 μm.

13. (canceled)

14. The water supply of claim 1, further comprising a heat engine to drive one or both of said water evaporation system and said airflow driving system.

15. (canceled)

16. (canceled)

17. A method of supplying, desalinating or purifying water, comprising:
using solar energy to provide heat to humidified air in a pipe; and
providing water to an evaporation station from the sea and locating a condensation station on land at least 100 m from the sea, and at an elevation greater than that of said evaporation station, wherein said elevation is at least 100 m.

18. (canceled)

19. The method of claim 17 further comprising
storing sea water for use in the system during the day and operating the system, including driving said airflow, at night, and heating said stored sea water using solar energy.

20. (canceled)

21. (canceled)

22. (canceled)

23. (canceled)

24. (canceled)

25. The method of claim 1 further comprising
extracting energy from the gravitational potential energy of said extracted water.

26. The method of any one of claims 17 to 25 further comprising
adjusting a humidity of said humidified air at said evaporation station such that said humidity is not substantially greater than that needed for a threshold relative humidity of said humidified air at said condensation station.

27. The method of claim 26 wherein
said threshold relative humidity is substantially 100%.

28. The method of any one of claims 17 to 27 further comprising
supplying heat to said pipe from an external source.

29. The method of claim 28 further comprising
storing said externally supplied heat adjacent said pipe.

30. (canceled)

31. A water supply system, comprising:
an evaporation station, the evaporation station comprising a water inlet, an air conduit, and a water evaporation system;
wherein said water evaporation system is coupled to said water inlet to receive water for evaporation and has a water spray outlet into said air conduit to convert water from said water inlet into water vapour for humidifying air in said air conduit by spray evaporation, to provide humidified air;
a condensation station having an air inlet to receive said humidified air, a water outlet, and a water condensation system coupled to said air inlet and to said water outlet to extract water from said humidified air and provide said extracted water to said water outlet;
a pipe coupled between said air conduit of said evaporation station and air inlet of said condensation station; and
a system for driving an airflow through said air conduit of said evaporation station past said water evaporation system to enhance said spray evaporation;
wherein said evaporation station is located adjacent a lake or the sea; and
wherein said condensation station is located to employ a natural temperature difference for said extraction of said water from said humidified air.

32. The water supply system of claim 31 wherein
said condensation station is located at raised altitude such that the system is configured to employ a thermocline for said extraction of said water from said humidified air.

33. The water supply system of claim 31 wherein
said condensation station is located in a desert or similar environment in which at night the ambient temperature drops faster than that adjacent said sea or lake, and
wherein the system is configured to employ a difference in day-night temperature differential between said evaporation station and said condensation station for said extraction of said water from said humidified air.
